(19) United States
(12) Patent Application Publication
(10) Pub. No.: US 2013/0270341 A1
(43) Pub. Date: Oct. 17, 2013

(54) ELECTRONIC LABELING SYSTEM, DEVICE, AND METHOD

(71) Applicant: Dawda Janneh, Raleigh, NC (US)

(72) Inventor: Dawda Janneh, Raleigh, NC (US)

(21) Appl. No.: 13/833,596

(22) Filed: Mar. 15, 2013

Related U.S. Application Data
(60) Provisional application No. 61/611,908, filed on Mar. 16, 2012.

(51) Int. Cl. G06F 17/30

(52) U.S. Cl. CPC G06F 17/30
USPC 235/383

(57) ABSTRACT

The present subject matter relates to systems, devices, and methods for generating a product label in which a price gun can comprise a barcode scanner configured to retrieve identification information from a label provided on a product having one or more individually-identifiable product characteristics, a communications module for communicating with a central database to retrieve product information associated with the product, and a label printer configured to selectively generate a product label containing the product information.

### CROSS REFERENCE TO RELATED APPLICATION

This application relates and claims priority to U.S. Provisional Patent Application Ser. No. 61/611,908, filed Mar. 16, 2012, the entire disclosure of which is incorporated herein by reference.

### TECHNICAL FIELD

The subject matter disclosed herein relates generally to labeling for retail products. More particularly, the subject matter disclosed herein relates to systems, devices, and methods for reading and printing retail information labels.

### BACKGROUND

In a retail environment, particularly in a food market, most packaged products have a bar code printed thereon that is readable at a point-of-sale device to retrieve pricing information for the product. Such merchandising requires no price marking on the product being sold, and therefore many stores provide shelf tags instead, which display product identifying information and associated prices, all in human readable form.

For products provided in non-standardized package sizes (e.g., products sold by weight), however, individualized prices are often still provided on the products themselves. In addition, perishable items with limited shelf lives (e.g., meats, cheeses, bakery products) are often further provided with individualized sell-by, expiration, or other freshness dating. For these kinds of products, each item must be individually labeled with the relevant product information that is at least somewhat specific to that particular item.

When this information changes, however, such as due to price reductions, changes in the freshness criteria, or other changes in the information to be provided to the consumer, an employee of the store generally must generate new data labels containing the updated information for each item for which the information has changed. These labels are commonly generated using simple price guns that can only generate a few characters on a small sticker. Furthermore, the price and/or date information to be updated needs to be manually keyed into such devices. Thus, the store employee must first look up the new information from a reference chart or the like, adjust the price gun to print the new information, and print and affix the new label to the product. This process can be time-consuming and tedious, and the possibility of human error can result in items being mismarked.

As a result, it would be desirable for a system, device, and method to be able to more efficiently generate new product labels for items of this kind.

### SUMMARY

In accordance with this disclosure, systems, devices, and methods for reading and printing retail information labels are provided. In one aspect, the present subject matter relates to a “smart” price gun for use in a retail environment (e.g., a grocery store) that can scan bar codes, communicate with a central database, and print current/updated pricing and expiration date information, thus avoiding a stock clerk from having to look up and key in the information manually with a common date gun. Specifically, for example, the price gun can comprise a barcode scanner configured to retrieve identification information from a label provided on a product having one or more individually-identifiable product characteristics, a communications module for communicating with a central database to retrieve product information associated with the product, and a label printer configured to selectively generate a product label containing the product information.

In another aspect, a system for labeling retail products can comprise a central database comprising product information for one or more products each having one or more individually-identifiable product characteristics and a hand-held price gun. The price gun can itself comprise a barcode scanner configured to retrieve identification information from a label provided on a product selected from the one or more products, a communications module for communicating with the central database to retrieve the product information associated with the product, and a label printer configured to selectively generate a product label containing the product information.

In yet another aspect, a method for generating a product label using a single integrated price gun is provided. The method can comprise retrieving identification information from a label provided on a product having one or more individually-identifiable product characteristics using a hand-held price gun, communicating with a central database to retrieve product information associated with the product, and selectively generating a product label containing the product information.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a schematic view of a system for labeling retail products according to an embodiment of the presently disclosed subject matter;

FIG. 2A is side view of a “smart” price gun according to an embodiment of the presently disclosed subject matter;

FIG. 2B is a side perspective view of the “smart” price gun shown in FIG. 2A;

FIG. 3A is a top perspective view of a “smart” price gun according to another embodiment of the presently disclosed subject matter; and

FIG. 3B is a front perspective view of the “smart” price gun shown in FIG. 3A.

### DETAILED DESCRIPTION

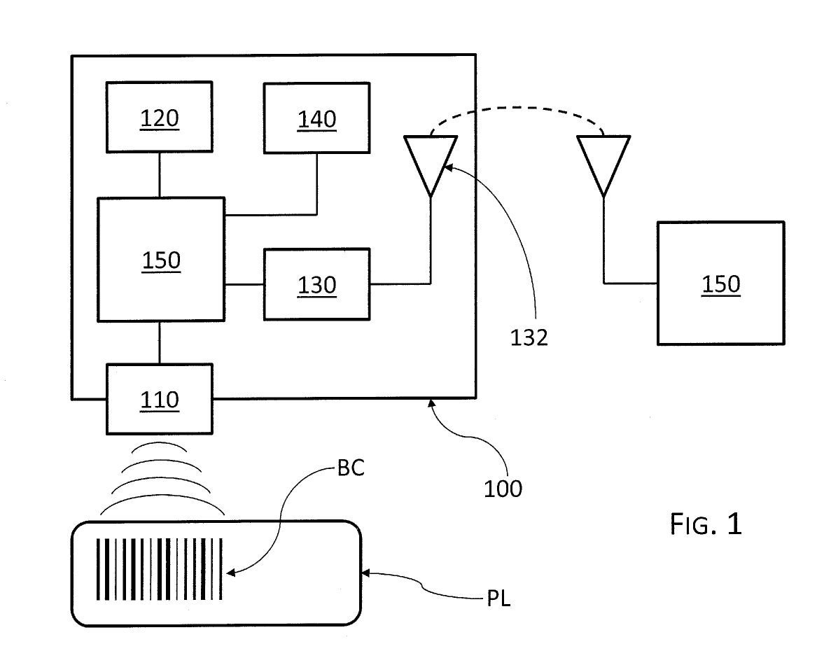

The present subject matter provides a “smart” price gun for use in a retail environment (e.g., a grocery store) that can scan bar codes, communicate with a central database, and print current/updated pricing and/or expiration date information, in particular related to products (e.g., grocery items in non-standardized package sizes) that have individually-identifiable product characteristics (e.g., weight, individually-calculated price, sell-by date). In one aspect shown in FIG. 1, for example, the present subject matter provides an electronic price gun, generally designated 100, comprising a control module 150 (e.g., a chip-based microcontroller) and a barcode scanner 110 selectively controllable by the control module 150 and configured to retrieve identification information from a product label PL provided on a product having individually-identifiable product information (e.g., weight, individually-calculated price, sell-by date, expiration date). For instance, the barcode scanner 110 can scan a barcode BC printed on an existing product label PL provided on the product to identify the product much in the same way as a point-of-sale device at the store's checkout. In this regard, the price gun 100 can further comprise a display screen 120, and the control module 150 can be configured to display the identification information acquired from the barcode BC on the display screen 120.

The price gun 100 can also comprise a communications module 130 configured for communicating with a central database 200 upon request from the control module 150 to retrieve product information associated with that particular product (i.e., retrieving product information associated singularly/uniquely with an individual product). Specifically, for example, the price gun 100 can send a request to the central database 200 to look up the desired product information associated with the product identified (e.g., associated with the scanned barcode BC). In response to this request, the product information can be retrieved from the central database 200 and transmitted back to the price gun 100. In particular, such information can comprise current pricing data, item expiration information or suggested “sell by” dates, or any other individualized information that is desired to present to the consumer for that particular item. The communication between the price gun 100 and the central database 200 can be performed wirelessly, such as by sending and receiving radio frequency signals. Accordingly, the communications module 130 can comprise one or more radio antennas 132 configured to transmit and receive this information.

Once the product information is received from the central database 200, it can be compared to information provided on the label. For instance, the product information can be displayed on the display screen 120 of the price gun 100, and the store employee can compare the displayed information to information provided on the product label PL. If the product information retrieved from the central database 200 is different than the information provided on the product label PL (e.g., reduced price, modified sell-by date), the store employee can selectively generate a revised product label containing the accurate product information. In this regard, the price gun 100 can further comprise a label printer 140 integrated therein.

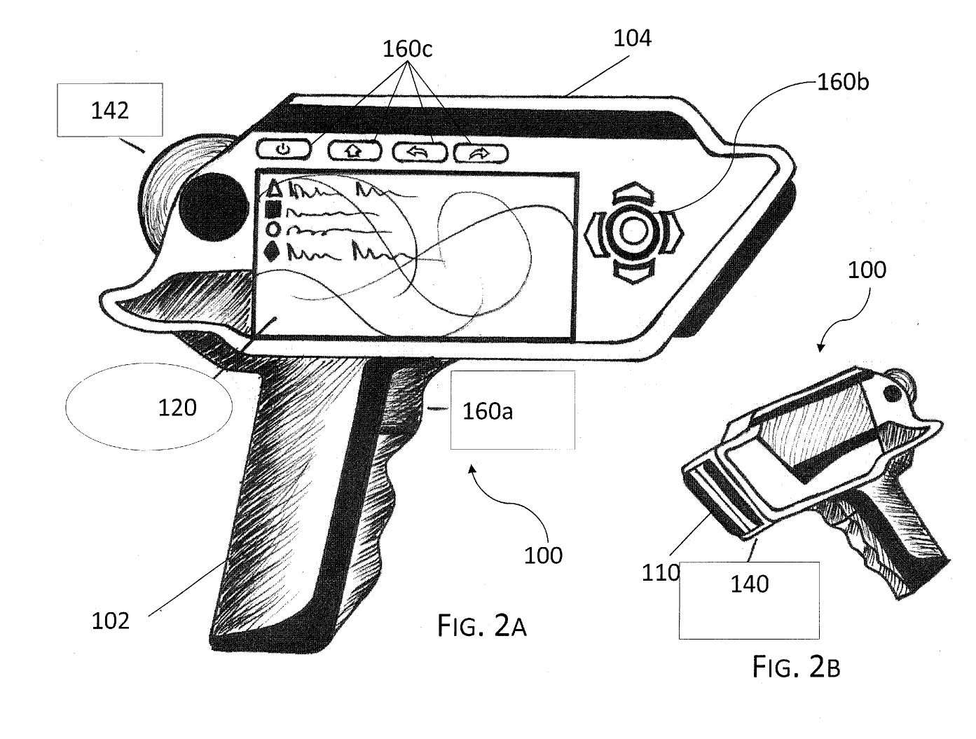

In fact, all of the components of the price gun 100 described hereinabove can be integrated together in a single, hand-held unit. For example, an exemplary configuration for the price gun 100 is shown in FIGS. 2A and 2B. As shown in FIGS. 2A and 2B, the price gun 100 can be configured in the form of a conventional pricing gun, with a grip handle 102 and a body portion 104 mounted to an end of the grip handle 102. Contrary to conventional pricing guns, however, the price gun 100 according to the present-disclosed subject matter can include the electronic scanning, communication, display, and printing components discussed hereinabove. Specifically, for example, the price gun 100 can comprise the barcode scanner 110 mounted on a forward-facing end of the body portion 104. The forward-facing end of the body portion 104 can further include the printer 140, which can draw from a label supply 142 (e.g., a roll of blank adhesive labels) that is likewise integrated with the price gun 100.

The display screen 120 can further be mounted to the body portion 104 of the price gun. As shown in FIG. 2A, for example, the display screen 120 can be mounted to one side of the body portion 104. In this arrangement, a store employee, such as a stock clerk, can use the price gun 100 to scan product labels PL for individually-packaged products (e.g., using scanner 110) while on the sales floor, retrieve up-to-date product information associated with the individually-packaged products (e.g., by communication with the central database 200 via the integrated communications module 130), view the up-to-date product information on the display screen 120, and selectively print a new label containing the up-to-date product information if desired using the printer 140.

User control of these steps can be enabled by one or more user controls. For example, as shown in FIG. 2A, the price gun 110 can comprise one or more of a trigger mechanism 160a, a multi-directional joystick 160b, and/or one or more push buttons 160c. One or more of these control features can be used, for example, to engage the scanner 110, interact with the product information on the display screen 120, and/or initiate the operation of the printer 140 to generate an updated product label. Alternatively or in addition, the display screen 120 can be a touch-screen device that allows the user to directly interact with on-screen interface control elements such as sliders, switches, menus, and buttons.

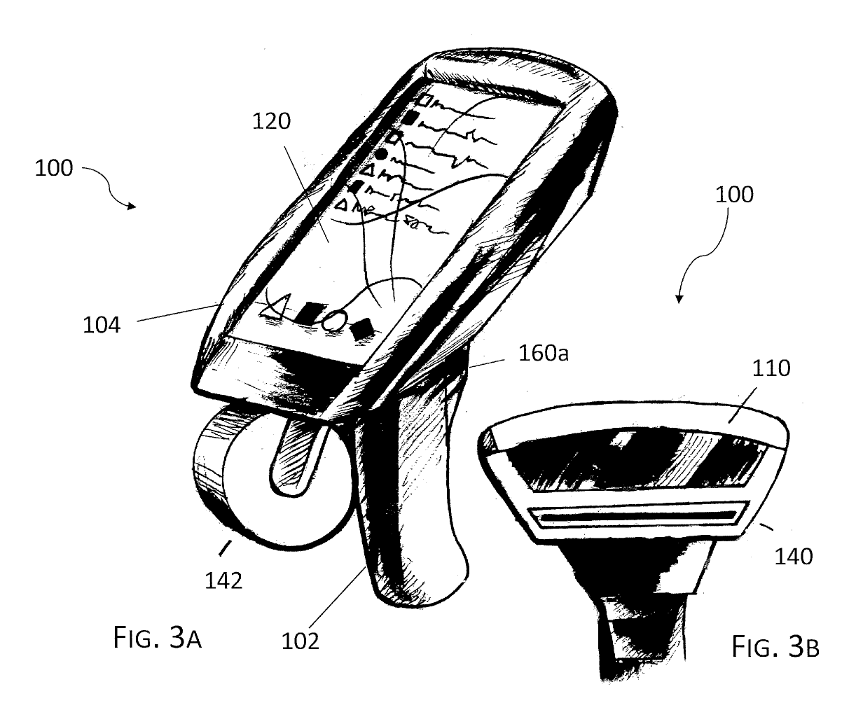

In another configuration of shown in FIGS. 3A and 3B, the price gun 100 can similarly include a grip handle 102 having a trigger mechanism 160a mounted thereon and a body portion 104 mounted to an end of the grip handle 102. A scanner 110 and printer 140 can be provided on a forward-facing end of the body portion 104, and a label supply 142 can be provided on a rear-facing end of the body portion 104. In contrast to the embodiment shown in FIGS. 2A and 2B, however, the display screen 120 can be mounted to a top surface of the body portion 104. In this arrangement, no external user controls are shown, but those having skill in the art will recognize that user control elements (e.g., a multi-directional joystick 160b, and/or one or more push buttons 160c) can be provided around the display screen 120 or elsewhere on the body portion 104 or grip handle 102 of the price gun 100. Alternatively or in addition, the display screen 120 can be a touch-screen device.

Regardless of the particular configuration of the price gun 100, the integration of one or more modules dedicated to product label scanning, communication with a central database, display of retrieved product information, and/or printing of new product labels can more efficiently enable the lookup of product information related to individually packaged/labeled products and the selective generation of new product labels for such items. As a result, the store employee need not look to a printed reference chart for updated prices or try to remember product lifespans. Rather, by scanning the product barcode BC and communicating wirelessly with the central database 200 using the present price gun 100, the desired information can be retrieved automatically. Further, instead of the store employee manually keying in the price and/or date information to be printed on the updated label, the price gun 100 can be configured to automatically convey the product information retrieved from the central database 200 to the label printer 140. Accordingly, the process of checking the validity of a product label PL and selectively printing a new label can be streamlined, and the possibility of human error in data lookup and entry can be substantially reduced.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A price gun comprising:
a barcode scanner configured to retrieve identification information from a label provided on a product having one or more individually-identifiable product characteristics;
a communications module for communicating with a central database to retrieve product information associated with the product; and
a label printer configured to selectively generate a product label containing the product information.

2. The price gun according to claim 1, wherein the product comprises a grocery item in a non-standardized package size.

3. The price gun according to claim 1, wherein the communications module comprises one or more radio frequency antennas configured to wirelessly transmit the identification information to the central database and receive the product information from the database.

4. The price gun according to claim 1, wherein the product information comprises one or more of a product price, “sell by” date, or product expiration date.

5. The price gun according to claim 1, further comprising a display screen configured to display the identification information retrieved by the barcode scanner and/or the product information retrieved from the central database.

6. The price gun according to claim 5, comprising one or more user control features configured to interact with interface control elements displayed on the display screen.

7. The price gun according to claim 6, wherein the display screen comprises a touch-screen device; and
wherein the interface control elements comprise on-screen interface control elements displayed on the touch-screen device.

8. The price gun according to claim 1, wherein the price gun is a hand-held device.

9. A system for labeling retail products comprising:
a central database comprising product information for one or more products each having one or more individually-identifiable product characteristics; and
a hand-held price gun comprising:
a barcode scanner configured to retrieve identification information from a label provided on a product selected from the one or more products;
a communications module for communicating with the central database to retrieve the product information associated with the product; and
a label printer configured to selectively generate a product label containing the product information.

10. The system of claim 9, wherein the product comprises a grocery item in a non-standardized package size.

11. The system of claim 9, wherein the retail product information comprises one or more of a product price, a “sell by” date, or a product expiration date.

12. The system of claim 9, wherein the price gun further comprises a display screen configured to display the identification information retrieved by the barcode scanner and/or the product information retrieved from the central database.

13. The price gun according to claim 12, comprising one or more user control features configured to interact with interface control elements displayed on the display screen.

14. The price gun according to claim 13, wherein the display screen comprises a touch-screen device; and
wherein the interface control elements comprise on-screen interface control elements displayed on the touch-screen device.

15. A method for generating a product label using a single integrated price gun, the method comprising:
retrieving identification information from a label provided on a product having one or more individually-identifiable product characteristics using a hand-held price gun;
communicating with a central database to retrieve product information associated with the product; and
selectively generating a product label containing the product information.

16. The method of claim 15, wherein retrieving identification information comprises scanning a barcode provided on the label.

17. The method of claim 15, wherein the product comprises a grocery item in a non-standardized package size.

18. The method of claim 15, wherein communicating with a central database comprises wirelessly transmitting the identification to the central database and receiving the product information from the database.

19. The method of claim 15, wherein the product information comprises one or more of a product price, a “sell by” date, or a product expiration date.

20. The method of claim 15, comprising comparing the product information retrieved from the central database to information provided on the label;
wherein selectively generating a product label is performed if the product information retrieved from the central database is different than the information provided on the label.
